(19) United States
(12) Patent Application Publication
(10) Pub. No.: US 2006/0097474 A1
(43) Pub. Date: May 11, 2006

(54) STEM FOR A BICYCLE

(75) Inventor: Jim Liao, Hsin Chu-Hsien (TW)

Correspondence Address: TROXELL LAW OFFICE PLLC, SUITE 1404, 5205 LEESBURG PIKE, FALLS CHURCH, VA, 22041, US

(73) Assignee: Hsin Lung Accessories Co., Ltd.

(21) Appl. No.: 10/984,786

(22) Filed: Nov. 10, 2004

(51) Int. Cl. B62K 21/00

(52) U.S. Cl. 280/279

(57) ABSTRACT

A stem for a bicycle comprises a lateral tube having one end provided with two toothed sections respectively at both sides thereof, and another end provided with a clamp member for securing a handle; an adaptor including a ringed clamp having a recess and a connecting rod laterally secured onto the ringed clamp, the recess being used for securing onto a front fork; and a left fixing member and a right fixing member of substantially the same shape and structure as the left fixing member, the fixing members each having one end provided with a locking hole for securing the fixing members to two ends of the connecting rod, respectively, and another end provided with a toothed section for meshing in engagement with the tooth sections of the lateral tube, respectively.

### BACKGROUND OF THE INVENTION

1. Field of the Invention

The present invention relates to a stem, in particular to a stem for a bicycle which can be adjusted in angle.

2. Description of the Related Art

FIG. 1 shows a conventional stem of a bicycle which includes a lateral tube 1 soldered onto the peripheral wall at the top end of a vertical tube 2, and the bicycle handle 5 is fixed to a clamp member 4 at the front end of the lateral tube 1. Thus, the angle between the lateral tube 1 and the vertical tube 2 cannot be adjusted at all, i.e., the lateral tube 1 cannot be adjusted in the upward and downward direction and, in turn, the handle 5 secured to the clamp member 4 at the front end of the lateral tube 1 is not adjustable in height and consequently cannot provide satisfactory gripping of the handle 5 for riders of different heights. Thus, optimum riding comfort cannot be achieved.

### SUMMARY OF THE INVENTION

Accordingly, an object of the present invention is to provide a stem for a bicycle in which the height of the lateral tube can be adjusted as desired or required by a user, and in which the range of adjustment is considerably broad such that adjustment to any angle as desired by the rider can be made.

To realize the above object, the present invention provides a stem for a bicycle which comprises a lateral tube having one end provided with two toothed sections respectively at both sides thereof, and another end provided with a clamp member for securing a handle; an adaptor including a ringed clamp having a recess and a connecting rod laterally secured onto said ringed clamp, said recess being used for securing onto a front fork; and a left fixing member and a right fixing member of substantially the same shape and structure as said left fixing member, said fixing members each having one end provided with a locking hole for securing said fixing members to two ends of said connecting rod, respectively, and another end provided with a toothed section for meshing in engagement with said tooth sections of said lateral tube, respectively.

### BRIEF DESCRIPTION OF THE DRAWINGS

FIG. 1 is a perspective view of a conventional stem for a bicycle

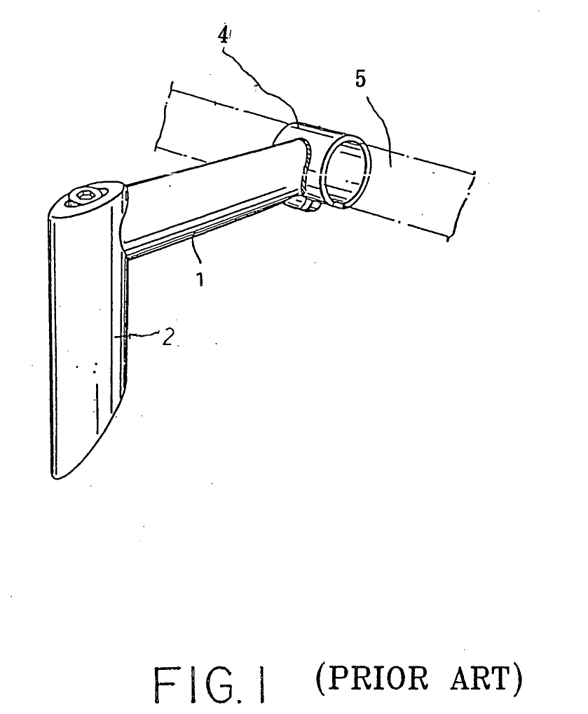

FIG. 2 is an exploded view of a bicycle stem according to the present invention;

FIG. 3 is a perspective view of the bicycle stem according to the present invention;

FIG. 4 shows the adjustment of angle of the bicycle stem according to the present invention; and

FIG. 5 shows an alternative embodiment of the bicycle stem according to the present invention.

### DETAILED DESCRIPTION OF THE PREFERRED EMBODIMENT

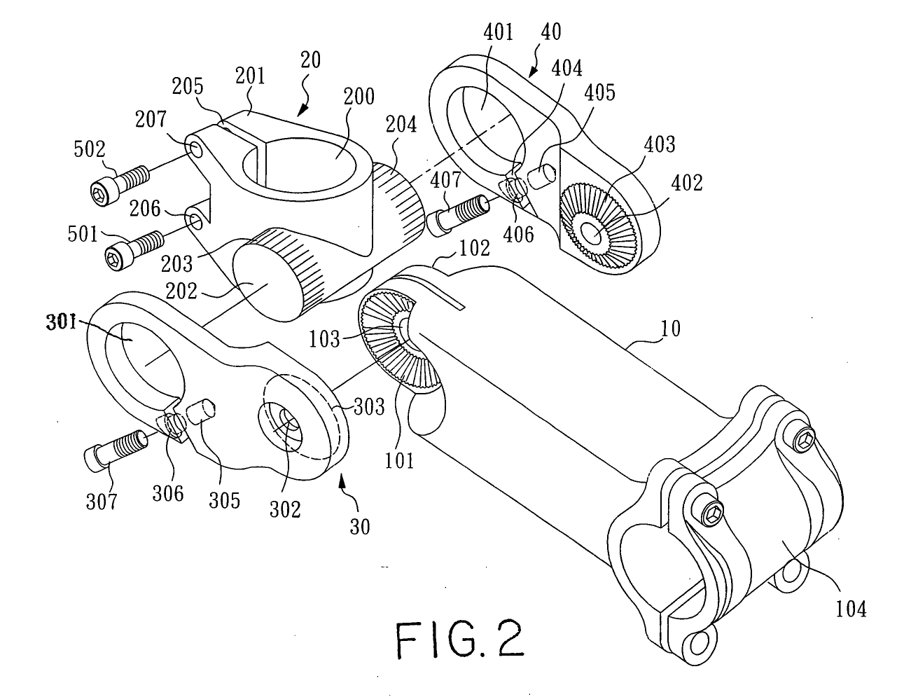

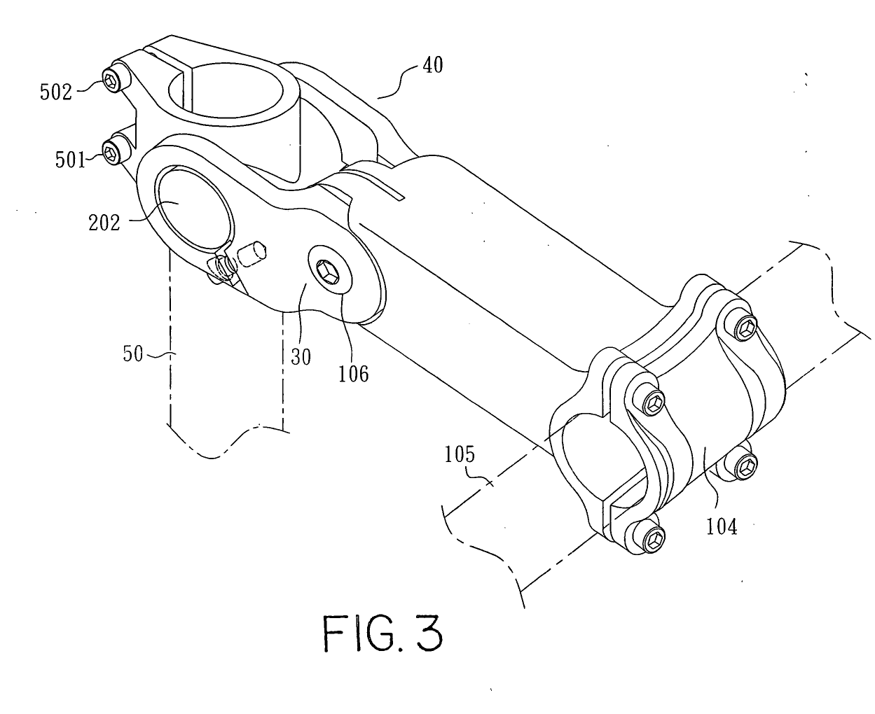

With reference to FIG. 2 in conjunction with FIG. 3, the stem for a bicycle according to a preferred embodiment of the present invention generally comprises a lateral tube 10, an adaptor 20, a left fixing member 30 and a right fixing member 40.

The lateral tube 10 has one end provided with two toothed sections 101,102 respectively at both sides thereof, with a slot 103 passing therethrough, and another end provided with a clamp member 104 for securing a handle 105.

The adaptor 20 includes a ringed clamp 201 having a recess 200 and a connecting rod 202 laterally clamped by the ringed clamp 201. Two ridged portions 203,204 are respectively provided externally around the two opposing ends of the rod 202. The ringed clamp 201 has a gap 205 which is in communication with the recess 200, and a plurality of locking holes on a side thereof In this embodiment, two such holes 206,207 are illustrated.

The left and right fixing members 30,40 have completely the same structure and shape. Thus, for the sake of brevity, only one of these fixing members, namely the right fixing member 40, will be described herein. The right fixing member 40 has one end provided with a bore 401 and another end provided with a toothed section 403 and a slot 402 passing therethrough, and further has a gap 404 defined by the middle portion thereof which is in communication with the bore 401. A threaded hole 405 is formed at the upper part of the gap 404 and a corresponding through-hole 406 is formed at the opposite lower part of the gap 404. Thus, the gap 404 can be closed or narrowed by inserting a threaded bolt 407 through the through-hole 406 and screwing the same into the threaded hole 405.

In the assembly operation, the recess 200 of the adaptor 20 is sleeved onto the front fork 50. The gap 205 is closed or just narrowed by using two threaded bolts 501,502 inserted and screwed into the locking holes 206,207, so as to secure the ringed clamp 201 onto the front fork 50. Then, the bore 401 of one of the fixing members 40 is sleeved onto the rod 202, and the bolt 407 is inserted into the through-hole 406 and screwed in the threaded hole 405, so as to close or just narrow the gap 404 and thus secure the fixing member 40 onto the connecting rod 202. Subsequently, the lateral tube 10 is adjusted to the required angle, and thereafter, the toothed sections 303,403 of the left and right fixing members 30,40 are meshed in engagement with the tooth sections 101,102 of the lateral tube 10 and are locked in place by using a bolt 106 which is respectively inserted into the slots 302,402,103. At the same time, a threaded bolt 307 is inserted into the through-hole 306 and screwed in the threaded hole 305 to fix the other fixing member 30 on the connecting rod 202.

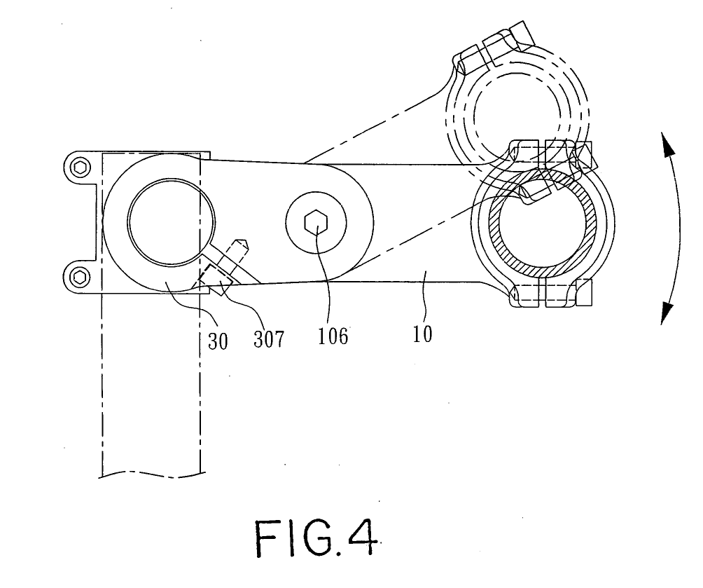

To adjust the angle of the lateral tube 10, the bolt 307,407 in one of the fixing members 30,40 is first loosened, along with the bolt 106. As illustrated in FIGS. 2 and 4, the bolt 307 of the fixing member 30 is loosened along with the bolt 106 so that the fixing member 30 is removed. Then the lateral tube 10 is slightly moved so that the toothed section 101 of the lateral tube 10 is unmeshed from the toothed section 403 of the fixing member 40. Therefore the lateral tube 10 is adjusted up and down to the required angle, the fixing member 30 is replaced, and the bolts 307,106 are re-inserted to lock.

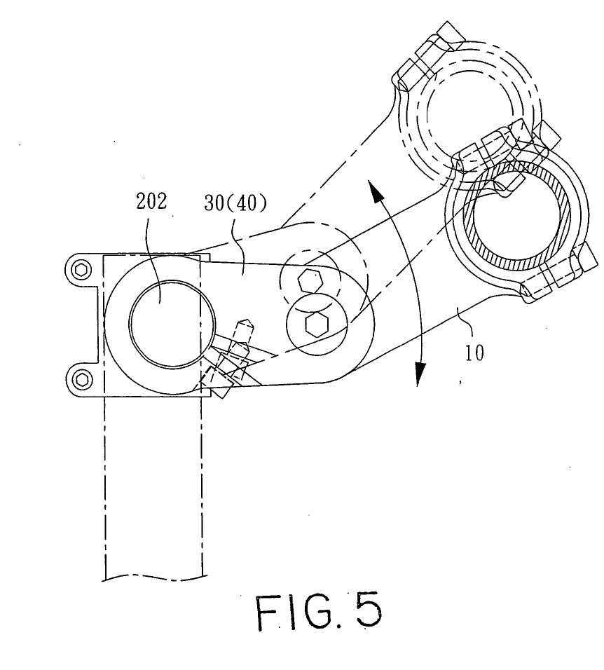

With reference to FIGS. 2 and 5, the bolts 307,407 of the fixing members 30,40 may be loosened so as to rotate the two fixing members 30,40 upwardly or downwardly to the necessary angle, and then tightened (the angle of the lateral tube 10 is not adjusted.) It can be appreciated that according to the present invention, the angle of the lateral tube or that of the fixing members 30,40 can be adjusted alone, or at the same time. Thus, the present invention can achieve a wide range of angle adjustment.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A stem for a bicycle, said stem having one end onto which a handle is mounted and another end which is secured to a front fork, comprising:
a lateral tube having one end provided with two toothed sections respectively at both sides thereof, and another end provided with a clamp member for securing said handle;
an adaptor including a ringed clamp having a recess and a connecting rod laterally secured onto said ringed clamp, said recess being used for securing onto said front fork; and
a left fixing member and a right fixing member of substantially the same shape and structure as said left fixing member, said fixing members each having one end provided with a locking hole for securing said fixing members to two ends of said connecting rod, respectively, and another end provided with a toothed section for meshing in engagement with said tooth sections of said lateral tube, respectively.

2. A stem for a bicycle as claimed in claim 1, wherein said tooth sections are all provided with slots at the center thereof into which a bolt may be inserted in place.
